(19) United States
(12) Patent Application Publication
(10) Pub. No.: US 2006/0080885 A1
(43) Pub. Date: Apr. 20, 2006

(54) Fishing rod aerial

(76) Inventor: Eric Wisocki, Duluth, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/249,621

(22) Filed: Oct. 13, 2005

Related U.S. Application Data
(60) Provisional application No. 60/619,252, filed on Oct. 15, 2004.

(51) Int. Cl. A01K 87/00

(52) U.S. Cl. 43/18.1 R

(57) ABSTRACT

A fishing rod is configured for use as either a decorative and functioning vehicle antenna or a fishing rod.

This application claims the benefit of U.S. Provisional Application No. 0/619,252 filed on Oct. 15, 2004, for “Fishing Rod Aerial” by E. Wisocki.

### BACKGROUND OF THE INVENTION

The present invention relates to an antenna for a vehicle. In particular, the invention is directed to a combination antenna and fishing rod.

Typical automobile antennas function solely to receive radio signals, which in turn are transformed into sound energy transmitted through the automobile's sound system. Antennas are elongated conductive rods, which are also the basic structure of many graphite fishing rods. U.S. Design Pat. D454,863 shows an antenna that looks like a fishing rod, however, this antenna is solely usable as an automobile antenna and not as a fishing rod.

### BRIEF SUMMARY OF THE INVENTION

The present invention is a fishing rod that is also configured for use as an antenna for a vehicle. The fishing rod includes an electrically conductive rod blank that is connected to a coupler via a connector. The coupler attaches the fishing rod to the vehicle. The fishing rod also includes guides and a handle.

### BRIEF DESCRIPTION OF THE DRAWINGS

FIGS. 1 and 2 are front views of the fishing rod aerial.

FIGS. 3 and 4 are perspective views of the fishing rod aerial attached to a vehicle.

FIG. 5 is a front view of the handle and coupling nut of the fishing rod aerial.

### DETAILED DESCRIPTION

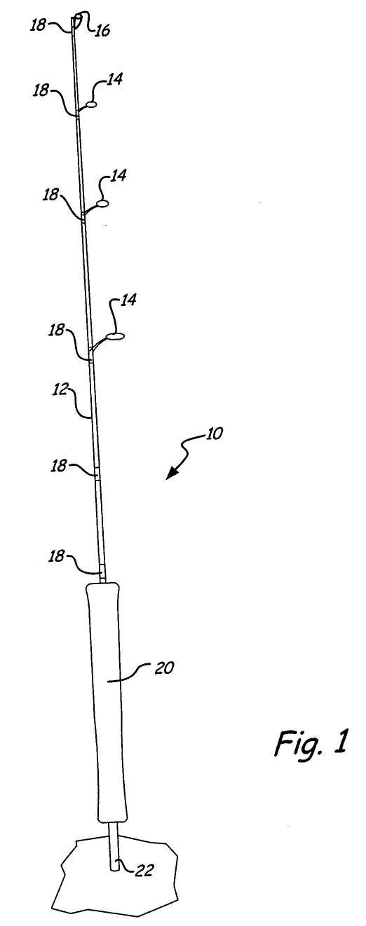

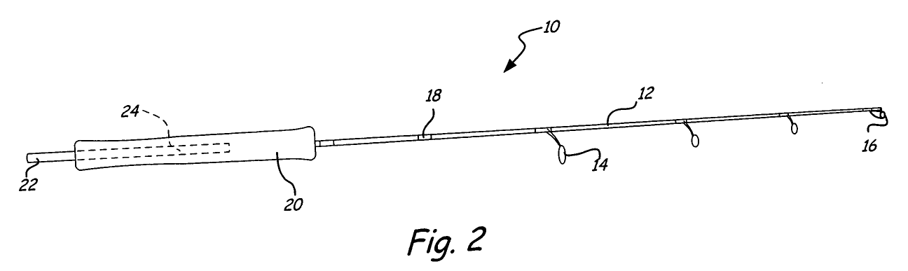

FIGS. 1 and 2 show fishing rod aerial 10. Aerial 10 includes rod blank 12, guides 14, tip-top guide 16, wraps 18, handle 20, and coupling nut 22. FIG. 2 further includes spring steel piece 24. Guides 14 and tip-top guide 16 are secured to rod blank 12 with wraps 18. Rod blank 12 extends from one end of handle 20, and coupling nut 22 extends from the opposite end of handle 20. Spring steel piece 24 is within handle 20 and connected to rod blank 12 and coupling nut 22 to provide an electrical connection.

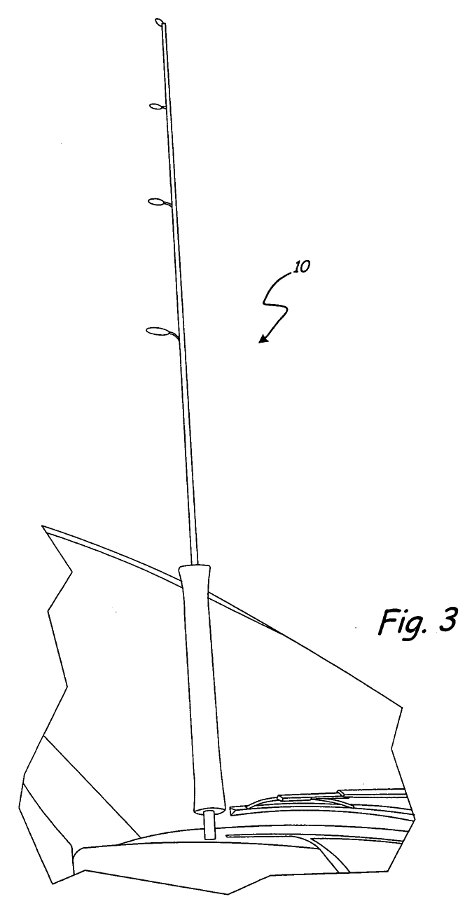

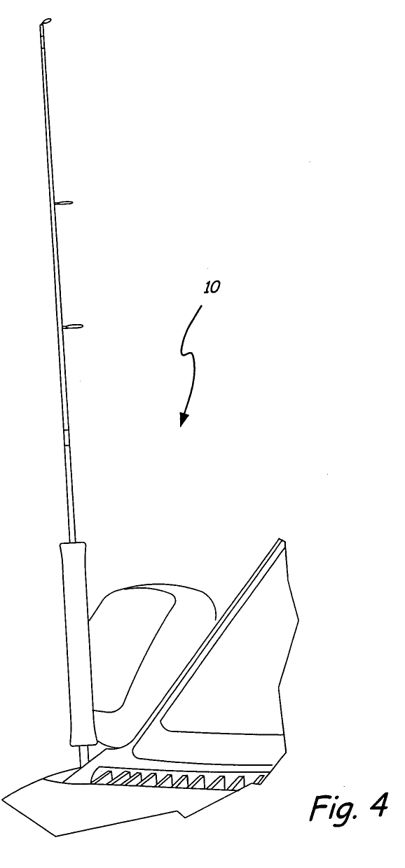

To use aerial 10 as an antenna, the factory antenna of a vehicle is removed, which reveals a factory bolt for connecting an antenna. A coupler, such as coupling nut 22, fastens onto the factory bolt on the vehicle. Other types of couplers that are attachable to the factory bolt may also be used. Aerial 10 is held upright and functions as an antenna. FIGS. 3 and 4 show aerial 10 attached to a vehicle.

To use aerial 10 as a fishing rod, aerial 10 is removed from the vehicle by unscrewing coupling nut 22 from the factory bolt, and a reel is attached to handle 20. Thus, aerial 10 is a decorative antenna for a vehicle, while also working as a fishing rod.

Rod blank 12 is composed of an electrically conductive material. Preferably, the material is an electrically conductive graphite composite, which has action for sensitivity to fish, rocks, weeds, and any other obstruction in the water and back bone that prevents rod blank 12 from breaking while catching a fish. Rod blank 12 has a length that is usable as a fishing pole. For use as an ice fishing rod, rod blank 12 has a length such that the length from tip top guide 16 to the opposing end of handle 22 is about 28 in.

Wraps 18 secure guides 14 and tip top guide 16 to rod blank 12. Wraps 18 are rod building thread, which comes in various colors and designs. Epoxy, a color preserve, and finish coat secure and seal wraps 18 to rod blank 12.

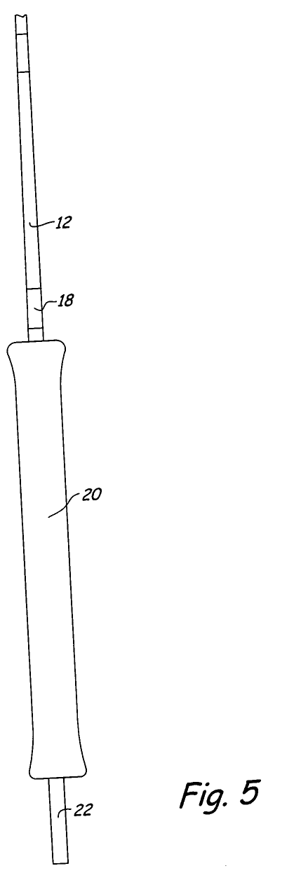

FIG. 5 shows handle 20 and coupling nut 22. Handle 20 is composed of cork, foam rubber, or any other similar type material and has a length that is between about 8 in. and about 10 in. Handle 20 allows aerial 10 to be held while fishing and provides for attachment of a reel. Sealant may be applied to handle 20 for protection from weather damage.

Spring steel piece 24 is a connector between rod blank 12 and coupling nut 22. Other types of connectors may also be used with aerial 10. One end of spring steel piece 24 is glued to the end of rod blank 12 opposite tip top guide 16. The other end of spring steel piece 24 is tapped into coupling nut 22. Handle 20 covers spring steel piece 24 and a portion of rod blank 12.

Aerial 10 is both a functional antenna and a fishing rod. It can be used to jig for walleyes, crappies, perch, and other fish, for example, or it can be a functioning antenna and decoration for the vehicles of fishing enthusiasts.

Although the present invention has been described with reference to preferred embodiments, workers skilled in the art will recognize that changes may be made in form and detail without departing from the spirit and scope of the invention.

1. A fishing rod usable as an antenna for a vehicle, the fishing rod comprising:
an electrically conductive rod blank having a length usable for fishing;
a connector attached to the rod blank;
a coupler attached to the connector, the coupler for attaching the fishing rod to the vehicle;
a plurality of guides attached to the rod blank; and
a handle covering the connector and a portion of the rod blank.

2. The fishing rod of claim 1 and further comprising:
wraps for securing the guides to the rod blank.

3. The fishing rod of claim 1 wherein one of the plurality of guides is a tip top guide.

4. The fishing rod of claim 1 wherein the connector is composed of spring steel.

5. The fishing rod of claim 1 wherein the connector has a length between about 6 in. and 7 in.

6. The fishing rod of claim 1 wherein the coupler is a coupling nut.

7. The fishing rod of claim 1 wherein the handle has a length between about 8 in. and 10 in.

8. The fishing rod of claim 1 wherein the rod blank is composed of a graphite composite material.

9. An ice fishing rod configured such that it can also be used as an antenna for a vehicle, the ice fishing rod comprising:
an electrically conductive graphite composite rod blank, having a length usable for ice fishing;
a coupling nut for attaching the ice fishing rod to the vehicle and detaching the ice fishing rod from the vehicle, wherein the coupling nut threads onto a bolt on the vehicle;
a spring steel piece connecting the coupling nut and the graphite composite rod blank;
a handle covering a proximal end of the graphite composite rod blank and the spring steel piece, and configured so that a fishing reel is attachable;
a plurality of guides located on the graphite composite rod blank; and
a wrap to secure the guides to the graphite composite rod blank.

10. The ice fishing rod of claim 9, wherein the spring steel piece is glued into the proximal end of the graphite composite rod blank and tapped into the coupling nut.

11. The ice fishing rod of claim 9, wherein the handle is made of cork or rubber.

12. The ice fishing rod of claim 11, further comprising a cork sealant applied to the cork handle for protecting the handle from weather damage.

13. The ice fishing rod of claim 9, wherein the guides include a tip-top guide placed over a distal end of the graphite composite rod blank.

14. The ice fishing rod of claim 9, wherein the wrap is a type of thread used on fishing rods.

15. The ice fishing rod of claim 14, wherein the thread is available in various colors and designs.

16. The ice fishing rod of claim 14, further comprising a finish coat applied over the wrap.
